(19) United States
(12) Patent Application Publication
(10) Pub. No.: US 2018/0163966 A1
(43) Pub. Date: Jun. 14, 2018

(54) FUEL SUPPLY SYSTEM

(71) Applicant: ROLLS-ROYCE PLC, London (GB)

(72) Inventors: David I. Jones, Bristol (GB); Michael Whiteman, Derby (GB); Daniel J. Bickley, Derby (GB)

(73) Assignee: ROLLS-ROYCE PLC, London (GB)

(21) Appl. No.: 15/821,268

(22) Filed: Nov. 22, 2017

(30) Foreign Application Priority Data
Dec. 9, 2016 (GB) 1620999.1

(51) Int. Cl. F23R 3/28; F02C 7/22; F02C 7/236; F02C 9/26

(52) U.S. Cl. CPC F23R 3/283; F02C 7/222; F02C 7/236; F05D 2260/602; F23K 2203/105; F23D 2209/30; F05D 2270/301; F02C 9/263

(57) ABSTRACT

A fuel supply system for fuel injectors of a multi-stage combustor of a gas turbine engine. The fuel supply system includes a metering and splitting arrangement which receives a total fuel flow and controllably meters and splits the received total fuel flow into metered pilot and mains flows. The fuel supply system further includes a de-priming sub-system, one or more fuel lines of a mains fuel distribution pipework being fluidly connected to the mains fuel discharge orifices and extending to the de-priming sub-system, and the de-priming sub-system being configured to remove the mains fuel from the injectors. A re-priming sub-system, the one or more fuel lines of the mains fuel distribution pipework also extending to the re-priming sub-system, and the re-priming sub-system being configured to refill the injectors with mains fuel through the one or more fuel lines when the mains distribution pipework is selected for pilot and mains operation.

### FIELD OF THE INVENTION

The present invention relates to a fuel supply system for fuel injectors of a multi-stage combustor of a gas turbine engine.

### BACKGROUND

Multi-stage combustors are used particularly in lean burn fuel systems of gas turbine engines to reduce unwanted emissions while maintaining thermal efficiency and flame stability. For example, duplex fuel injectors have pilot and mains fuel manifolds feeding pilot and mains discharge orifices of the injectors. At low power conditions only the pilot stage is activated, while at higher power conditions both pilot and mains stages are activated. The fuel for the manifolds typically derives from a pumped and metered supply. A splitter valve can then be provided to selectively split the metered supply between the manifolds as required for a given staging.

A typical annular combustor has a circumferential arrangement of fuel injectors, each associated with respective pilot and mains feeds extending from the circumferentially extending pilot and mains manifolds. Each injector generally has a nozzle forming the discharge orifices which discharge fuel into the combustion chamber of the combustor, a feed arm for the transport of fuel to the nozzle, and a head at the outside of the combustor at which the pilot and mains feeds enter the feed arm. Within the injectors, a check valve, known as a flow scheduling valve (FSV), is typically associated with each feed in order to retain a primed manifold when de-staged and at shut-down. The FSVs also prevent fuel flow into the injector nozzle when the supply pressure is less than the cracking pressure (i.e. less than a given difference between manifold pressure and combustor gas pressure).

Multi-stage combustors may have further stages and/or manifolds. For example, the pilot manifold may be split into two manifolds for lean blow-out prevention during rapid engine decelerations.

During pilot-only operation, the splitter valve directs fuel for burner flow only through the pilot fuel circuit (i.e. pilot manifold and feeds). It is therefore conventional to control temperatures in the de-staged (i.e. mains) fuel circuit to prevent coking due to heat pick up from the hot engine casing. One known approach, for example, is to provide a separate recirculation manifold which is used to keep the fuel in the mains manifold cool when it is deselected. It does this by keeping the fuel in the mains manifold moving, although a cooling flow also has to be maintained in the recirculation manifold during mains operation to avoid coking.

FIG. 1 shows schematically a combustion staging system 130 for a gas turbine engine. A metered fuel flow arrives at the staging system at a pressure P_{fmu}. The staging system splits the fuel into two flows: one at a pressure Pₚ for first 131a and second 131b segments of a pilot manifold and the other at a pressure Pₘ for a mains manifold 132. Fuel injectors 133 of a combustor of the engine are split into two groups. The injectors of one group are connected to the first pilot manifold segment 131a, while the injectors of the other group are connected to the second pilot manifold segment 131b. The mains manifold feeds secondary discharge orifices of the fuel injectors. Pilot FSVs 139 and mains FSVs 140 at the injectors prevent fuel flow into the injectors when the pressure difference between the upstream manifold and the downstream combustion chamber is below the cracking point of the valve (i.e. at conditions where the mains is de-staged and at shut down). The FSVs also prevent combustion chamber gases entering the respective manifolds if the downstream pressure exceeds a manifold pressure. By varying the fuel split between the manifolds, staging control of the engine can be performed.

In more detail, the staging system 130 has a fuel flow splitting valve (FFSV) 134, which receives the metered fuel flow from a hydromechanical unit (HMU) at pressure P_{fmu}. A spool is slidable within the FFSV under the control of a servo-valve 135, the position of the spool determining the outgoing flow split between a pilot connection pipe 136 which delivers fuel to the pilot manifold segments 131a, b and a mains connection pipe 137 which delivers fuel to the mains manifold 132. The spool can be positioned so that the mains stage is deselected, with the entire metered flow going to the pilot stage. A position sensor 138 provides feedback on the position of the spool to an engine electronic controller (EEC), which in turn controls staging by control of the servo-valve.

Between the FFSV 134 and the second pilot manifold segment 131b, the pilot connection pipe 136 communicates with a lean blow out protection valve 150 which controls communication between the pilot connection pipe 136 and the second pilot manifold segment 131b. The lean blow out protection valve is spring biased towards an open position. A solenoid operated control valve 152 is operable to apply a control pressure to the valve member of the lean blow out protection valve to move it against the action of the spring so that the valve is biased to a closed position, restricting the communication between the pilot connection pipe 136 and the second pilot manifold segment 131b, when required. Accordingly, if there is only a pilot delivery of fuel to the engine and there is a concern that a lean blow out condition may occur, the lean blow out protection valve 150 can be closed by appropriate control of the solenoid operated control valve 152, with the result that fuel delivery to the second pilot manifold segment 131b is restricted, whilst that to the first pilot manifold segment 131a is increased. Adequate pilot delivery through the reduced number of injectors fed by manifold segment 131a can therefore be assured, resulting in a reduced risk of a lean blow-out condition occurring.

The staging system 130 also has a recirculation line to provide the mains manifold 132 with a cooling flow of fuel when the mains manifold is deselected. The recirculation line has a delivery section including a delivery pipe 141 which receives the cooling flow from a fuel recirculating control valve (FRCV) 142, and a recirculation manifold 143 into which the delivery pipe feeds the cooling flow. The recirculation manifold has feeds which introduce the cooling flow from the recirculation manifold to the mains manifold via connections to the feeds from the mains manifold to the mains FSVs 140.

In addition, the recirculation line has a return section which collects the returning cooling flow from the mains manifold 132. The return section is formed by a portion of the mains connection pipe 137 and a branch pipe 144 from the mains connection pipe, the branch pipe extending to a recirculating flow return valve (RFRV) 145 from whence the cooling flow exits the recirculation line.

The cooling flow for the recirculation line is obtained from the HMU at a pressure HP_{f} via a cooling flow orifice (CFO) 146. On leaving the RFRV 145 via a pressure raising orifice (PRO) 147, the cooling flow is returned to the pumping unit for re-pressurisation by the HP pumping stage. A check valve 148 accommodates expansion of fuel trapped in the pilot and mains system during shutdown when the fuel expands due to combustor casing heat soak back. The check valve can be set to a pressure which prevents fuel boiling in the manifolds. The FRCV 142 and the RFRV 145 are operated under the control of the EEC. The HMU also supplies fuel at pressure HP_{f} for operation of the servo-valve 135, the RFRV 145, and the lean blow out protection valve 150.

When mains is staged in, a cooling flow is also directed through the recirculation manifold 143 to avoid coking therein. More particularly a small bypass flow is extracted from the HMU's metered fuel flow at pressure P_{fmu}. The bypass flow is sent via a flow washed filter 149 to a separate inlet of the FRCV 142, and thence through the delivery pipe 141 to the recirculation manifold 143. The bypass flow exits the recirculation manifold to rejoin the mains fuel flow at the injectors 133.

However, a problem with such a system is how to accommodate a mains FSV 140 failing to an open condition. In pilot-only operation, when cooling flow is passing through the recirculation manifold 143 and the mains manifold 132, such a failure can result in the cooling flow passing through the failed open FSV through one injector into the combustors, causing a hot streak which may lead to nozzle and turbine damage. In pilot and mains operation, such a failure can produce a drop in mains manifold pressure which causes other mains FSVs to close. A possible outcome is again that a high proportion of the total mains flow passes through the failed open FSV to one injector, causing a hot streak leading to nozzle and turbine damage.

In principle, such failure modes can be detected by appropriate thermocouple arrangements, e.g. to detect hot streaks. However, temperature measurement devices of this type can themselves have reliability issues.

Further, the problem of mains FSV failure can be exacerbated by system arrangements used to prevent combustion chamber gas ingress through the fuel injectors 133 during pilot only operation. Whilst the impact of such gas ingress is generally non-hazardous, it can lead to hot gas-induced degradation of FSV seals. Degraded FSV sealing can in turn lead to dribbling of fuel into de-staged nozzles, resulting in component blockage due to coking. For example, the system may be modified to make orifice 147 variable under servo-valve control so that the deselected mains manifold pressure can be controlled to maintain it at a level below that required to crack open the mains FSVs 140 but above combustion chamber pressure in order to prevent ingestion of hot combustion chamber gases past the FSV seals. A disadvantage of such an arrangement is that in the event of a mains FSV 140 failing open, the system system may try to maintain manifold pressure above combustion chamber gas pressure (which can be taken to be approximately the same as the measured engine parameter P30—the high pressure compressor outlet pressure), and thus may react by delivering more flow to the fuel injectors. This further increases the risk of reducing nozzle and turbine life.

### SUMMARY

It would be desirable to address these problems.

Accordingly, in a first aspect, the present invention provides a fuel supply system for fuel injectors of a multi-stage combustor of a gas turbine engine, the fuel supply system including:
a metering and splitting arrangement which receives a total fuel flow and controllably meters and splits the received total fuel flow into metered pilot and mains flows for injecting respectively at pilot and mains fuel discharge orifices of the injectors to perform staging control of the combustor; and
pilot and mains fuel distribution pipeworks respectively distributing fuel from the metering and splitting arrangement to the pilot and mains discharge orifices;
wherein the metering and splitting arrangement is operable to select the pilot distribution pipework and deselect the mains distribution pipework for pilot-only operation in which there is a pilot supply to the combustor but no mains supply to the combustor from the injectors, and is operable to select both the pilot and mains distribution pipeworks for pilot and mains operation in which there are pilot and mains supplies to the combustor from the injectors;
wherein fuel supply system further includes a de-priming sub-system, one or more fuel lines of the mains fuel distribution pipework being fluidly connected to the mains fuel discharge orifices and extending to the de-priming sub-system, and the de-priming sub-system being configured to remove the mains fuel from the injectors through the one or more fuel lines when the mains distribution pipework is deselected for pilot-only operation; and
wherein the fuel supply system further includes a re-priming sub-system, the one or more fuel lines of the mains fuel distribution pipework also extending to the re-priming sub-system, and the re-priming sub-system being configured to refill the injectors with mains fuel through the one or more fuel lines when the mains distribution pipework is selected for pilot and mains operation.

Thus in contrast to the system shown in FIG. 1, by de-priming the mains path in the injectors (removing mains fuel) when mains is de-staged and re-priming the mains path in the injectors (refilling with mains fuel) when mains is staged in, it becomes possible to perform staging control of a multi-stage combustor without a recirculating cooling flow to a mains manifold during pilot-only operation and without fuel scheduling valves in the mains fuel passages of the injectors. Thus many of the problems indicated above can be avoided whilst enabling a simplified system (e.g. by removing mains FSVs and cooling recirculation architecture) with associated mass, cost and reliability benefits.

The system also allows the injectors to have no pilot FSVs. These are not needed as the pilot supply flows continuously from the pilot fuel discharge orifices during normal operation, and can be reverse purged at shut down to prevent any leakage into the injectors and combustor. The reverse purge can be achieved, for example, by providing a manifold drain valve under the action of combustion chamber gas pressure. Removal of the pilot FSVs is a further simplification with cost, mass and reliability benefits. It also eliminates any potentially hazardous failure modes associated with flow maldistribution and subsequent turbine torching which can occur as a result of a pilot FSV seizing in an open position.

In a second aspect, the present invention provides a gas turbine engine having a multi-stage combustor and the fuel supply system according to the first aspect for supplying fuel to and performing staging control in respect of pilot and mains fuel discharge orifices of fuel injectors of the combustor.

The gas turbine engine may further have a pumping unit to supply the fuel flow to the metering and splitting arrangement of the fuel supply system.

The fuel injectors may be without fuel scheduling valves in respect of their mains discharge orifices.

Optional features of the invention will now be set out. These are applicable singly or in any combination with any aspect of the invention.

The pilot fuel distribution pipework may include a pilot fuel manifold distributing fuel from the metering and splitting arrangement to the pilot discharge orifices. The pilot manifold may include a segment restrictable by a lean blow out protection valve to decrease the proportion of the pilot fuel flow delivered to the injectors fed by the segment relative to the total pilot fuel flow delivered to the remaining injectors of the combustor.

The metering and splitting arrangement may typically include: a metering valve (for example housed in an HMU) which receives and controllably meters the total fuel flow, and a splitting sub-arrangement which receives the total metered flow from the metering valve and controllably splits the total metered flow into the pilot and mains flows. For example, the splitting sub-arrangement can be a fuel flow splitting valve or a set of valves providing a splitting function. As another example, the splitting sub-arrangement can be: a secondary metering valve, a fuel line extending between the secondary metering valve and a first one of the pilot and mains fuel distribution pipeworks, and a spill valve which is operable to control a pressure drop across the secondary metering valve by diverting a controlled portion of the total metered flow in the fuel line to the other of the pilot and mains fuel distribution pipeworks. In the case that the fuel line extends between the secondary metering valve and the pilot fuel distribution pipework, the diverted controlled portion forms the mains flow. More particularly, by controlling the secondary metering valve pressure drop and valve position (e.g. under closed loop control achieved via a servovalve and position sensor), it is possible to set a pilot flow, the mains flow being the difference between total metered flow and pilot metered flow. In the case that the fuel line extends between the metering valve and the mains fuel distribution pipework, the diverted controlled portion forms the pilot flow. Another option, however, is for the metering and splitting arrangement to include: a pilot metering valve which receives and controllably meters a portion of the fuel flow for onward flow to the pilot distribution pipework, and a mains metering valve in parallel to the pilot metering valve, the mains metering valve receiving and controllably metering a different portion of the fuel flow for onward flow to the mains distribution pipework, wherein the relative values of the fuel flows controllably metered by the pilot and mains metering valves determine the staging control split of the pilot and mains flows. The pilot and mains metering valves can be in a single HMU or separate HMUs.

A pumping unit which supplies the fuel flow to the metering and splitting arrangement of the fuel supply system may have a low pressure pumping stage and high pressure pumping stage arranged in flow series. The low pressure pumping stage can be centrifugal pump, and the high pressure pumping stage can be a positive displacement pump (e.g. one more gear pumps). However, when the metering and splitting arrangement includes a mains metering valve in parallel to a pilot metering valve, the pumping unit may have dedicated and respective high pressure pumping stages for these two metering valves.

The fuel supply system may further have a controller to control the metering and splitting arrangement and the de-priming and re-priming sub-systems. For example, the controller can be an element of an engine electronic controller (EEC).

The de-priming sub-system may be further configured to remove mains fuel from portions of the mains fuel distribution pipework adjacent the injectors when the mains distribution pipework is deselected for pilot-only operation, and the re-priming sub-system may be further configured to refill said portions of the mains fuel distribution pipework with mains fuel when the mains distribution pipework is selected for pilot and mains operation. For example, the de-priming sub-system may remove fuel from substantially the entirety of the one or more fuel lines when the mains distribution pipework is deselected for pilot-only operation, and the re-priming sub-system may refill the one or more fuel lines when the mains distribution pipework is selected for pilot and mains operation. Typically the more fuel is removed during the de-priming, the longer time is required for re-priming. However, in general, enough fuel should be removed so as to effectively remove a risk of fuel egress into the injectors, causing coking.

Each injector may have a dedicated and respective one of the fuel lines, such that each injector can be de-primed and re-primed independently of the other injectors. This can enable a high degree of control over the de-priming and re-priming, but at the cost of increased complexity of the system.

Another option is for the mains fuel distribution pipework to include plural mains manifolds for the supply of respective groups of the injectors with corresponding portions of the mains flow, each mains manifold having a dedicated and respective one of the fuel lines, such that the each group of injectors can be de-primed and re-primed independently of the other groups of injectors. In this way, system complexity can be decreased, but at the expense of some loss of controllability. The injectors of each group of injectors may be neighbouring injectors in the combustor. This can help to reduce gravitational head effects between the injectors. Typically there may be just two or just three injectors in each group of injectors. When there are two injectors in each group of injectors, another option is for the two injectors to be at the same vertical height in the combustor. This can also help to reduce gravitational head effects.

Yet another option, however, is for the mains fuel distribution pipework to include: a single mains manifold for the supply of all the injectors with corresponding portions of the mains flow, and a single fuel line fluidly connected to the mains fuel discharge orifices and extending to the de-priming and re-priming sub-systems.

Each of the one or more fuel lines may have a top portion at an end thereof and a bottom portion at an opposite end thereof, and be routed such that its injector(s) is at the top end and the de-priming sub-system is at the bottom end. In this way, if the fuel line is not fully emptied, the fuel should not egress into its fuel injector(s).

The de-priming sub-system may include one or more sinks in which the removed fuel is stored, the re-priming sub-system emptying the sink(s) to perform refilling using the stored fuel. Such an arrangement can help to increase the speed and accuracy of the re-priming. Indeed, when there are plural fuel lines, each may have a dedicated sink.

When there are plural fuel lines, the re-priming sub-system may be configured to perform refilling through the fuel lines at different times and/or different rates for different fuel lines. This can help to reduce dips and spikes during mains fuel staging. More generally, a controller (e.g. an EEC) which controls the de-priming and re-priming sub-systems can be configured to control each de-priming or re-priming sub-system independently of the other de-priming and re-priming sub-systems.

Conveniently, the fuel supply system can include an actuation unit which performs both de-priming and re-priming, such an actuation unit being a part of both the de-priming sub-system and the re-priming sub-system. For example, the actuation unit can comprise a positive displacement pump actuated by an electric motor to both remove the mains fuel from the injectors and refill the injectors with mains fuel. The actuation unit can be pneumatically, hydraulically, mechanically, electrically or electro-mechanically controlled. An electro-mechanical actuator may be a rotary to linear actuator (such as a motor and ball screw actuator or a motor and rack and pinion actuator) or a linear to linear actuator. In particular, when there are plural fuel lines, the fuel supply system may include plural actuation units which are each controllable to perform both de-priming and re-priming for a respective one of the fuel lines, the actuation units being parts of both the de-priming sub-system and the re-priming sub-system. The actuation units can also be configured to controllably fluidly isolate their respective fuel lines from the mains flow from the metering and splitting arrangement. This then enables the system to be used to perform partial (e.g. circumferential) mains staging in which not all of the mains discharge orifices are switched on. In particular, a controller (e.g. an EEC) which controls the actuation units can be configured to control each actuation unit independently of the other actuation units.

The, or each, fuel line may include a respective pressure and/or flow sensor which issues a signal when the fuel line is primed. When there are plural fuel lines, the signals can be used to control the order of fuel line re-priming. However, more generally the signal(s) allows re-priming failure to be monitored.

### BRIEF DESCRIPTION OF THE DRAWINGS

Embodiments of the invention will now be described by way of example with reference to the accompanying drawings in which:

FIG. 1 shows schematically a combustion staging system for a gas turbine engine in pilot and mains operation mode;

FIG. 2 shows a longitudinal cross-section through a ducted fan gas turbine engine;

FIG. 3 shows schematically a fuel supply system for fuel injectors of a multi-stage combustor of the gas turbine engine;

FIG. 4 shows schematically a variant fuel supply system for fuel injectors of the multi-stage combustor;

FIG. 5 shows schematically a further variant fuel supply system for fuel injectors of the multi-stage combustor; and

FIG. 6 shows schematically a further variant fuel supply system for fuel injectors of the multi-stage combustor.

DETAILED DESCRIPTION AND FURTHER OPTIONAL FEATURES

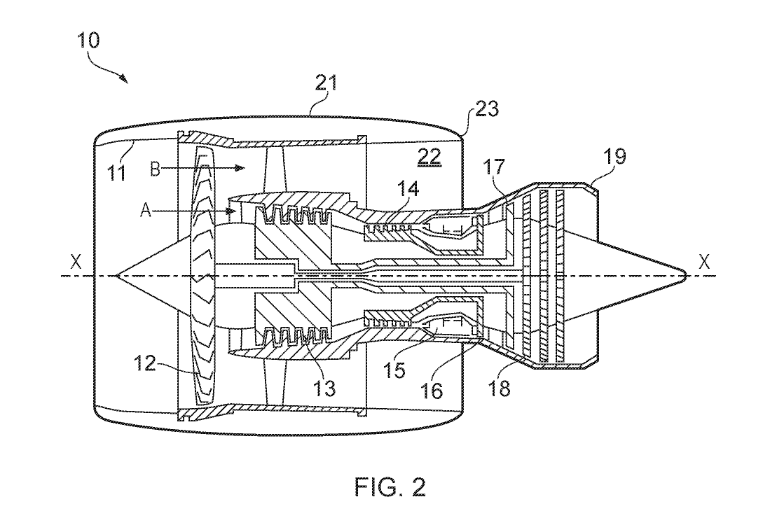

With reference to FIG. 2, a ducted fan gas turbine engine incorporating the invention is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate-pressure compressor 13 and a second air flow B which passes through the bypass duct 22 to provide propulsive thrust. The intermediate-pressure compressor 13 compresses the air flow A directed into it before delivering that air to the high-pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate-pressure compressors 14, 13 and the fan 12 by suitable interconnecting shafts.

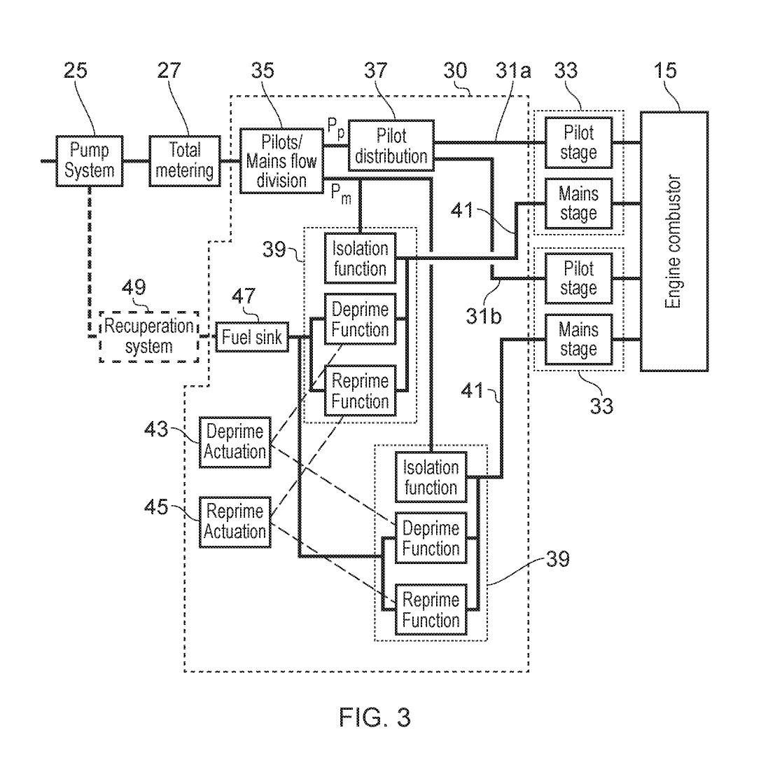

The combustion equipment 15 of the engine 10 includes a multi-stage combustor. FIG. 3 shows schematically a fuel supply system for fuel injectors of the multi-stage combustor. The engine has a pump system 25 comprising typically a low pressure (LP) pumping stage which draws fuel from a fuel tank of the aircraft and supplies the fuel at boosted pressure to the inlet of a high pressure (HP) pumping stage. The LP stage typically comprises a centrifugal impeller pump while the HP pumping stage may comprise one or more positive displacement pumps, e.g. in the form of twin pinion gear pumps. The LP and HP stages are typically connected to a common drive input, which is driven by the engine HP or IP shaft via an engine accessory gearbox.

The combustion equipment 15 of the engine 10 includes a multi-stage combustor. A fuel supply system accepts fuel from the HP pumping stage for feeding to the combustor. This system typically has a hydro-mechanical unit (HMU) 27 which performs total metering and comprises a fuel metering valve operable to control the rate at which fuel is allowed to flow to the combustor. The HMU further typically comprises: a pressure drop control arrangement (such as a spill valve and a pressure drop control valve) which is operable to maintain a substantially constant pressure drop across the metering valve, and a pressure raising and shut-off valve at the fuel exit of the HMU which ensures that a predetermined minimum pressure level is maintained upstream thereof for correct operation of any fuel pressure operated auxiliary devices (such as variable inlet guide vane or variable stator vane actuators) that receive fuel under pressure from the HMU. Further details of such an HMU are described in EP 2339147 A (hereby incorporated by reference).

An engine electronic controller (EEC) commands the HMU fuel metering valve to supply fuel to the combustor at a given flow rate. The metered fuel flow leaves the HMU and arrives at a staging system 30.

The staging system 30 splits the fuel into two flows: one at a pressure Pₚ for a pilot flow along pilot fuel distribution pipework to first 31a and second 31b segments of a pilot manifold and the other at a pressure Pₘ for a mains flow along mains fuel distribution pipework. Fuel injectors 33 (only two being shown in FIG. 3) of a combustor of the engine are split into two groups. Pilot (primary) discharge orifices of the injectors of one group are connected to the first pilot manifold segment 31a, while pilot discharge orifices of the injectors of the other group are connected to the second pilot manifold segment 31b. The mains flow feeds mains (secondary) discharge orifices of the fuel injectors.

A fuel flow splitting valve (FFSV) 35, or any other suitably-arranged set of valves known to the skilled person and providing a splitting function, receives the metered fuel flow from the HMU 27. Typically, the FFSV has a slidable spool under the control of a servo-valve, the position of the spool determining the outgoing flow split between two outlets forming respectively the pilot flow and the mains flow. The spool can be positioned so that the mains stage is completely deselected, with the entire metered flow going to the pilot stage. An LVDT can provide feedback on the position of the spool to the EEC, which in turn controls staging by control of the servo-valve.

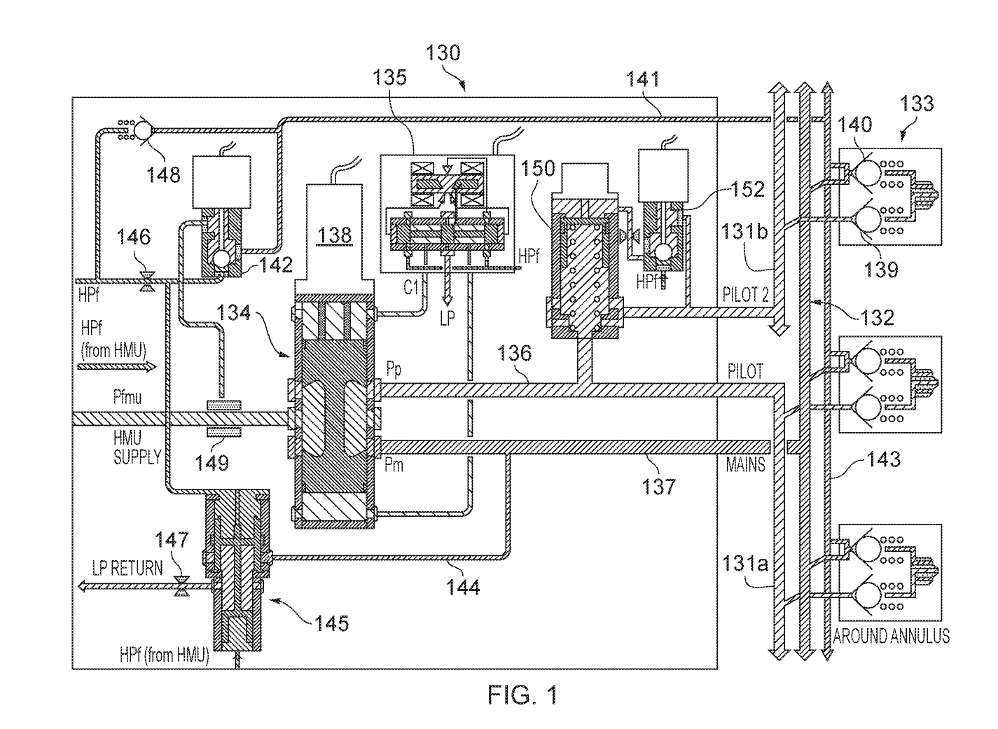

The pilot fuel distribution pipework has a distributor function 37 to split the pilot flow between the first 31a and second 31b segments of the pilot manifold. The distributor function can be a dedicated unit or can be a functional result of the operation of other parts of the staging system 30. A lean blow out protection valve and a solenoid operated control valve of the type shown in FIG. 1 may be part of the distributor function 37.

The mains fuel distribution pipework splits the mains flow into sub-flows, one for each injector, or one for each of different groups of the injectors. Each sub-flow is directed to a respective actuation unit 39 which performs de-prime and re-prime functions (discussed in more detail below) on its injector/group of injectors. In the case of each injector having a dedicated actuation unit, a respective fuel line 41 extends from each actuation unit to its injector. In the case of each of different groups of the injectors having a dedicated actuation unit, a respective fuel line 41 extends from each actuation unit to e.g. a manifold or other distributor serving the injectors of the group. Each such group may have just two or three injectors, and these are typically neighbouring injectors in the combustor in order to reduce gravitational head effects between the injectors. However, another option for reducing gravitational head effects is for each group to be formed of two injectors which are at the same vertical height in the combustor, i.e. reflected across the vertical plane containing the engine axis.

Optionally, each actuation unit 39 can also perform an isolation function. This allows the actuation units to controllably isolate their injector(s) from the mains flow from the FFSV 35, so that the EEC can perform partial mains staging. Typically this involves staging in a subset of the injectors, the injectors of the subset being equally circumferentially spaced around the combustor. Partial mains staging can help to maintain combustion performance at the mains discharge orifices of the injectors at low mains flow conditions.

The fuel supply system aims to improve on combustion staging systems of the type shown in FIG. 1 by removing a requirement for individual check valves (mains FSVs) at the mains injector heads. As discussed above, FSVs can inadvertently cause injector-to-injector fuel flow variation, which can potentially reduce the life of the combustor and turbine gas path components. Removing FSVs can also provide cost, weight and reliability benefits. The staging system 30 removes the requirement for such valves by de-priming the mains fuel passages of the injectors (and preferably also the fuel lines 41) when the mains flame is staged-out, and then re-priming the mains fuel passages of the injectors (and the fuel lines if necessary) prior to the mains flame being staged back in.

In particular, the actuation units 39 are under the control of the EEC, which performs a de-prime actuation function 43 and a re-prime actuation function 45. Thus the actuation units 39 and the de-prime actuation function 43 of the EEC together form a de-priming sub-system which removes the mains fuel from the injectors 33 through the fuel lines 41 when the mains distribution pipework is deselected for pilot-only operation, while the actuation units 39 and the re-prime actuation function 45 of the EEC together form a re-priming sub-system which refills the injectors with mains fuel through the fuel lines when the mains distribution pipework is selected for pilot and mains operation. The actuation units typically comprise suitably configured pumps and/or valves to perform these fuel removal and fuel refill functions. They may be pneumatically, hydraulically, mechanically or electrically controlled.

Each fuel line 41 can be routed vertically with its fuel injector(s) 33 at the top and its actuation unit 39 at the bottom. This helps to ensure that if the fuel line is not fully emptied, then the fuel does not egress into the fuel injector(s), causing coking of the injector nozzle(s).

The de-priming sub-system may include one or more sinks in which the removed fuel is stored. The re-priming sub-system can then empty the sink(s) to perform refilling using the stored fuel. For example, each actuation unit 39 may comprise a sink in the form of a reservoir, tank, accumulator or lower pressure area, with de-prime being initiated by the actuation unit opening its fuel line 41 to the sink. The fuel removed into the sink can be retained therein to be used for re-priming prior to staging. Advantageously, such an arrangement can reduce the time needed to refill in re-priming, and helps to avoid under- and over-fuelling the pilot and mains flames respectively.

Another option, however, is for the removed fuel to be recycled by a recuperation system 49 e.g. into the pump system 25, in which case the fuel to be used for refilling on re-priming can be provided by flow from the HMU 27 and the FFSV 35.

The amount of fuel that is removed during de-priming is dependent on the fuel system architecture. However, enough should be removed to ensure that no fuel can egress into the injectors 33, causing coking. To this end, the amount removed preferably accounts for thermal expansion of fuel remaining in the fuel lines 41 due to heat pick up from the environment, and aircraft manoeuvres. Indeed, one option is simply to remove all the fuel in the fuel lines, although this can increase the time required for re-priming.

As mentioned above, the fuel supply system permits the removal of mains FSVs and hence mitigates associated issues/risks (e.g. mal-scheduling due to a failed open FSV; nozzle-to-nozzle fuel distribution variation due to FSV-to-FSV component variation; and lifing issues such as seal wear/degradation leading to fuel dribbling and consequent nozzle coking).

However, a further advantage of the fuel supply system is that it can provide individual flow stream control for re-prime and subsequent staging, which can help to reduce/eliminate fuel dips. It also allows valves to be moved away from the burner head into a more benign environment, providing for improved control of component temperatures, which in turn reduces the risk of degradation in component/system performance due to fuel coking. Further, as discussed above, the actuation units 39 can be configured such that they may be controlled by the EEC to isolate their respective fuel lines 41 from the mains flow from the FFSV 35.

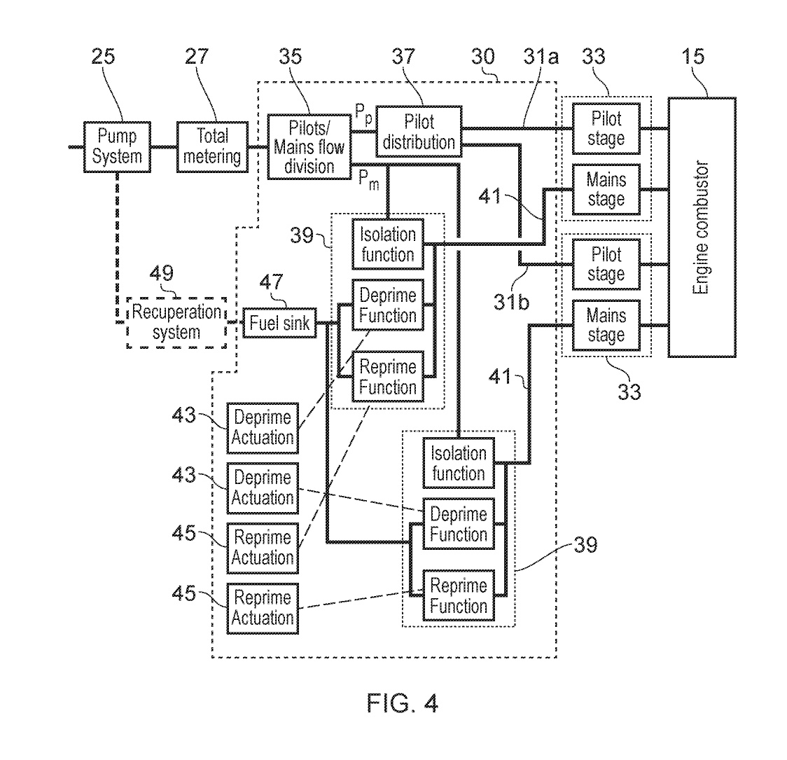

FIG. 4 shows schematically a variant fuel supply system for fuel injectors of the multi-stage combustor. In the variant system, the EEC has a separate de-prime actuation function 43 for each actuation unit, and also a separate re-prime actuation function 45 for each actuation unit 39. This is particularly advantageous for re-priming, as the refill timings of each fuel line 41 can be staggered to reduce the magnitude of the dips and spikes during mains fuel staging. Also the separate de-prime actuation functions enable the EEC to control partial mains staging.

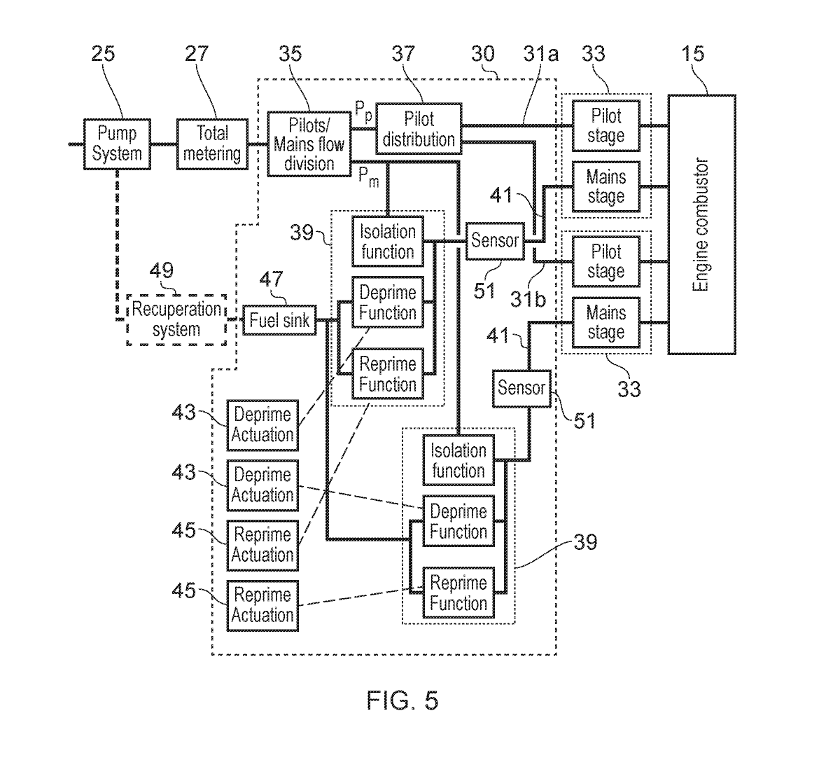

FIG. 5 shows schematically a further variant fuel supply system for fuel injectors of the multi-stage combustor. In the further variant system, a pressure sensor and/or a flow sensor 51 is provided in each fuel line 41 to determine when that fuel line is refilled, with a signal being sent to the EEC to initiate re-prime of the next fuel line. Also the pressure/flow sensing can be used by the EEC to determine if there are any failures in the re-prime function.

Another option, however, is to initiate re-prime all of the fuel lines 41 at the same time but to utilise different lengths of fuel line to reduce the magnitude of the dips and spikes during mains fuel staging (i.e. tuning the architecture of the mains distribution pipework). Yet another option is to control the relative refill rates of the fuel lines 41 to reduce the magnitude of the dips and spikes.

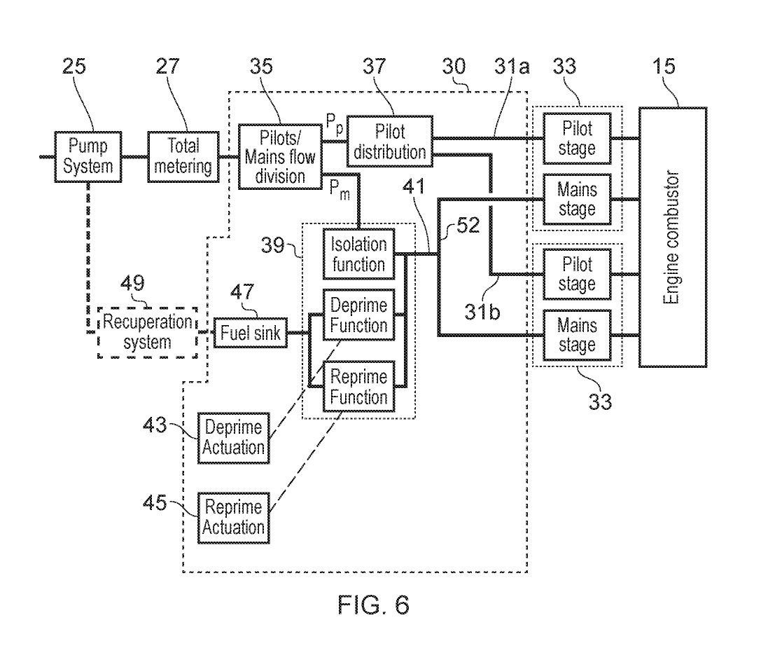

FIG. 6 shows schematically a further variant fuel supply system for fuel injectors of the multi-stage combustor. In this further variant system, the mains fuel distribution pipework has a single mains manifold 52 which distributes the mains flow to all the injectors 33. A single fuel line 41 extends from a single actuation unit 39 to the manifold. With this system, the de-prime/re-prime functionality of the actuation unit removes fuel from and refills the entire mains manifold in order that no fuel dribbles from a partially drained manifold through to injectors sited below the fuel level.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

What is claimed is:

1. A fuel supply system for fuel injectors of a multi-stage combustor of a gas turbine engine, the fuel supply system including:
a metering and splitting arrangement which receives a total fuel flow and controllably meters and splits the received total fuel flow into metered pilot and mains flows for injecting respectively at pilot and mains fuel discharge orifices of the injectors to perform staging control of the combustor; and
pilot and mains fuel distribution pipeworks respectively distributing fuel from the metering and splitting arrangement to the pilot and mains discharge orifices;
wherein the metering and splitting arrangement is operable to select the pilot distribution pipework and deselect the mains distribution pipework for pilot-only operation in which there is a pilot supply to the combustor but no mains supply to the combustor from the injectors, and is operable to select both the pilot and mains distribution pipeworks for pilot and mains operation in which there are pilot and mains supplies to the combustor from the injectors;
wherein fuel supply system further includes a de-priming sub-system, one or more fuel lines of the mains fuel distribution pipework being fluidly connected to the mains fuel discharge orifices and extending to the de-priming sub-system, and the de-priming sub-system being configured to remove the mains fuel from the injectors through the one or more fuel lines when the mains distribution pipework is deselected for pilot-only operation;
wherein the fuel supply system further includes a re-priming sub-system, the one or more fuel lines of the mains fuel distribution pipework also extending to the re-priming sub-system, and the re-priming sub-system being configured to refill the injectors with mains fuel through the one or more fuel lines when the mains distribution pipework is selected for pilot and mains operation; and
wherein the de-priming sub-system includes one or more sinks in which the removed fuel is stored, the re-priming sub-system emptying the sink(s) to perform refilling using the stored fuel.

2. A fuel supply system according to claim 1, wherein the pilot fuel distribution pipework includes a pilot fuel manifold distributing fuel from the metering and splitting arrangement to the pilot discharge orifices.

3. A fuel supply system according to claim 1, wherein the metering and splitting arrangement includes: a metering valve which receives and controllably meters the total fuel flow, and a splitting sub-arrangement which receives the total metered flow from the metering valve and controllably splits the total metered flow into the pilot and mains flows.

4. A fuel supply system according to claim 1, wherein the de-priming sub-system is further configured to remove mains fuel from portions of the mains fuel distribution pipework adjacent the injectors when the mains distribution pipework is deselected for pilot-only operation, and wherein the re-priming sub-system is further configured to refill said portions of the mains fuel distribution pipework with mains fuel when the mains distribution pipework is selected for pilot and mains operation.

5. A fuel supply system according to claim 1, wherein each injector has a dedicated and respective one of the fuel lines, such that each injector can be de-primed and re-primed independently of the other injectors.

6. A fuel supply system according to claim 1, wherein the mains fuel distribution pipework includes plural mains manifolds for the supply of respective groups of the injectors with corresponding portions of the mains flow, each mains manifold having a dedicated and respective one of the fuel lines, such that each group of injectors can be de-primed and re-primed independently of the other groups of injectors.

7. A fuel supply system according to claim 6, wherein the injectors of each group of injectors are neighbouring injectors in the combustor.

8. A fuel supply system according to claim 6, wherein there are just two or just three injectors in each group of injectors.

9. A fuel supply system according to claim 6, wherein there are two injectors in each group of injectors, the two injectors being at the same vertical height in the combustor.

10. A fuel supply system according to claim 1, wherein each of the one or more fuel lines has a top portion at an end thereof and a bottom portion at an opposite end thereof, and is routed such that its injector(s) is at the top end and the de-priming sub-system is at the bottom end.

11. A fuel supply system according to claim 1, wherein there are plural fuel lines, and the re-priming sub-system is configured to perform refilling through the fuel lines at different times and/or different rates for different fuel lines.

12. A fuel supply system according to claim 1, wherein:
there are plural fuel lines,
the fuel supply system includes plural actuation units which are each controllable to perform both de-priming and re-priming for a respective one of the fuel lines, the actuation units being parts of both the de-priming sub-system and the re-priming sub-system.

13. A fuel supply system according to claim 1, wherein the, or each, fuel line includes a respective pressure and/or flow sensor which issues a signal when the fuel line is primed.

14. A gas turbine engine having a multi-stage combustor and the fuel supply system according to claim 1 for supplying fuel to and performing staging control in respect of pilot and mains fuel discharge orifices of fuel injectors of the combustor.
